(19) United States
(12) Patent Application Publication
(10) Pub. No.: US 2018/0129240 A1
(43) Pub. Date: May 10, 2018

(54) Switching Device for an Agricultural Vehicle

(71) Applicant: AGCO International GmbH, Neuhausen (CH)

(72) Inventors: Alexander Barzen, Ettlingen (DE); Jan Weigand, Marktoberdorf (DE); Dirk Stallmeier, Marktoberdorf (DE)

(21) Appl. No.: 15/806,450

(22) Filed: Nov. 8, 2017

(30) Foreign Application Priority Data
Nov. 10, 2016 (GB) 1618997.9

(51) Int. Cl. G05G 1/01; A01B 76/00; G05G 1/015; G05G 1/04; G05G 1/02; G05G 1/08

(52) U.S. Cl. CPC G05G 1/01; A01B 76/00; G05G 1/08; G05G 1/04; G05G 1/02; G05G 1/015

(57) ABSTRACT

A switching device for use on an agricultural vehicle such as an agricultural tractor. The switching device has first and second switches, wherein the second switch is mounted on or carried by the first switch. The switches can be operated in different directions, to allow control of different variables by an operator. In a preferred aspect, the first and second switches are used to control related variables. As the second switch is provided on the first switch, accordingly an operator can easily interpret the control of the related variables, without having to look at the switching device.

### BACKGROUND

### Field of the Invention

The present invention relates to a switching device for an agricultural vehicle, and an agricultural vehicle having such a switching device.

### Discussion of Related Art

Agricultural or constructional vehicles are generally provided with a variety of vehicle components, e.g. front or rear hitches, loader devices, or other hydraulic or pneumatic circuits. Such components can comprise a number of related control variables, e.g. a depth, height, and/or extension length of a component.

U.S. Pat. No. 7,654,359 describes a switching device designed for increased operator comfort, having adjustment wheels switches for the control of a component variable of the tractor, with further rocker switches provided forward of the adjustment wheels switches, the rocker switches for control of additional variables related to the tractor component. However, an operator can easily become confused as to which variables are controlled by which switches, which can often result in the operator mistakenly actuating the wrong component. In addition, an operator may be required to look directly at the switching device and possibly remove their hand from the switching device in order to see where the rocker switches are located. Such actions can serve to divert the operator's attention, and can result in increased risk of operator discomfort or error.

It is an object of the invention to provide a switching device having a construction which allows for improved operator convenience and comfort.

### SUMMARY OF THE INVENTION

Accordingly, there is provided a switching device for an agricultural vehicle, the switching device comprising:

a first or primary switch moveable along a switch path in a first direction for control of a first or primary variable of the vehicle; and

a second or secondary switch moveable in a second direction different to said first direction for control of a second or secondary variable of the vehicle,

wherein the second switch is carried on the first switch.

Providing first and second or primary and secondary switches which are commonly located, where a second switch is mounted on the body of a first switch, allows an operator to easily control first and second variables without repositioning their fingers or hand. In addition, the first and second variables may be arranged as related control variables, such that an operator can easily identify that operation of the second switch results in control of a variable related to the variable which is controlled by the first switch. It will be understood that the first and second switches may be provided as simple pushbutton or “on/off” switches, or the switches may be provided as having multiple states or as continuously-variable switches.

Preferably, the first switch comprises a rotary switch.

In this case, adjustment of the first variable can be performed by rotation of the first switch along a rotary switch path, about a rotational axis. The rotary switch may comprise any suitable control device, e.g. an adjustment wheel, a scroll wheel, a switch dial.

Preferably, the first switch comprises an adjustment wheel, wherein the second switch is mounted on an outer rim of the adjustment wheel.

Providing the second switch on an outer rim of an adjustment wheel allows for ease of access to the second switch, as the first switch is rotated.

Preferably, the second switch comprises at least one of the following: a pushbutton switch, a rocker switch, a toggle switch, a scroll wheel.

Preferably, the switching device comprises an upper first switch and a lower first switch, the upper and lower first switches provided as concentric rotary switches, the upper and lower first switches having respective upper and lower second switches carried thereon.

In a particular embodiment, the first switch comprises a rotatable disc, the disc rotatable about a central axis for control of the first variable,

wherein the planar angle of the disc to the horizontal is adjustable, and

wherein the second switch is provided by adjustment of the planar angle of the disc to the horizontal, for control of the second variable.

A switching device wherein the second switch is provided by the adjustment of the planar angle of the first switch results in an operator being able to easily control the second variable, regardless of the rotational position of the rotatable disc.

Preferably, the switching device comprises an angle detector measuring the planar angle of the disc to the horizontal, for control of the second variable.

Preferably, the switching device is configured such that when the disc is parallel to the horizontal, the angle detector outputs a zero-crossing value.

In a further alternative embodiment, the first switch comprises a linear slide switch or linear shuttle switch.

In this case, adjustment of the first variable can be performed by movement of the slide or shuttle switch along a linear path, wherein the second switch is provided as mounted on the shuttle or body of the first switch.

There is further provided an agricultural vehicle, preferably an agricultural tractor, having at least one switching device as described above, and at least one vehicle component controlled by said at least one switching device.

Preferably, the first and second variables are related control parameters for control of the vehicle component, such that an operator can easily interpret the status of related control parameters based on the status of the first and second switches.

Preferably, the first variable controlled by the first switch sets an operating range for the vehicle component.

Preferably, the second variable controlled by the second switch operates the vehicle component within the operating range set by the first variable.

Such an operating range may comprise a component depth control limit, a height limit, and/or a length limit for a component.

Preferably, the second switch controls a depth, height and/or length value of the component, within the limits of the operating range set by the first switch.

### BRIEF DESCRIPTION OF THE DRAWINGS

Embodiments of the invention will now be described, by way of example only, with reference to the accompanying drawings, in which:

FIG. 1 is a side view of an agricultural tractor having a user control system according to the invention;

FIG. 2 is a perspective view of a switching device according to a first embodiment of the invention;

FIG. 3 is a further perspective view of the switching device of FIG. 2;

FIG. 4 is a perspective view of a switching device according to a second embodiment of the invention;

FIG. 5 is a further perspective view of the switching device of FIG. 3; and

FIG. 6 is a perspective view of a switching device according to a third embodiment of the invention.

The drawings are provided by way of reference only, and will be acknowledged as not to scale.

### DETAILED DESCRIPTION OF THE INVENTION

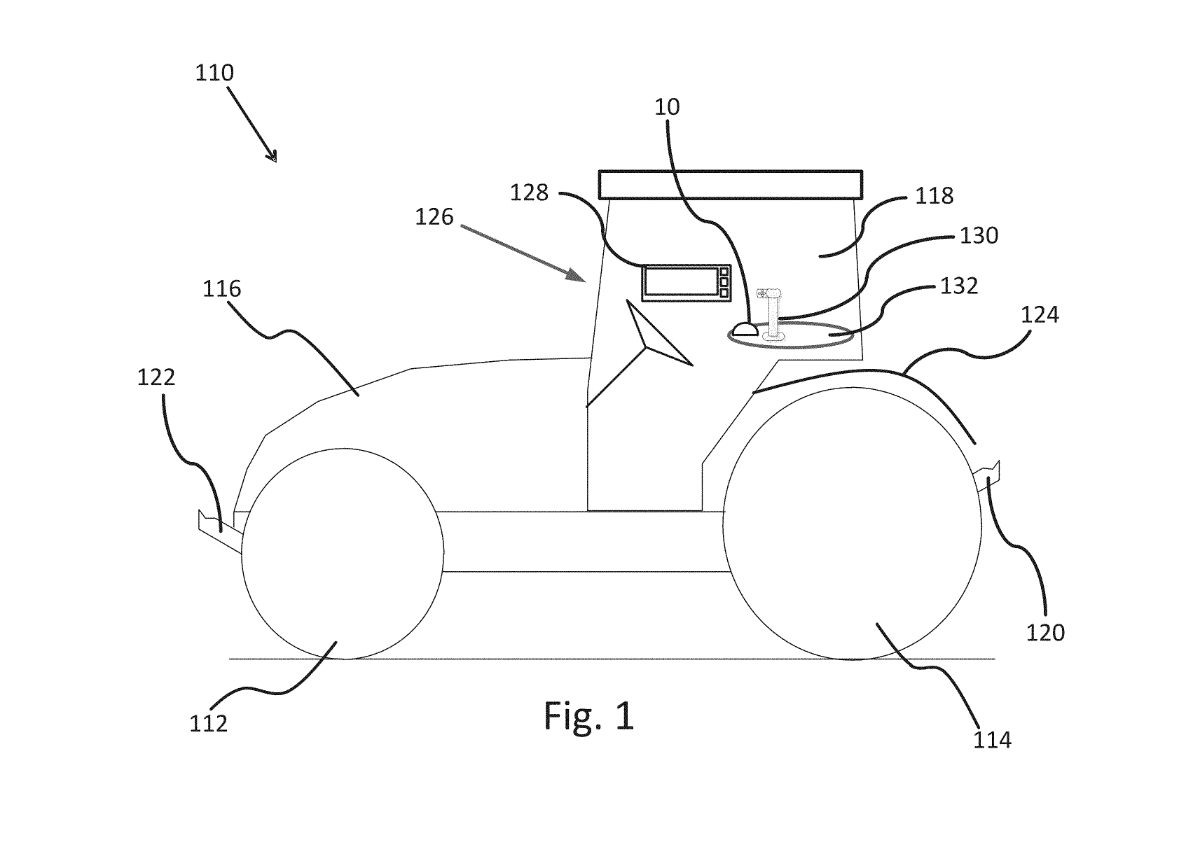

With reference to FIG. 1, a vehicle according to the invention in the form of an agricultural tractor is indicated at 110. The tractor 110 comprises front wheels 112 and rear wheels 114, a forward engine section 116 and a cab section 118. A rear linkage 120 is provided at the rear of the tractor 110, and a front linkage 122 is provided at the front of the tractor 110. The front and rear linkages 120, 122 can be actuated or moved using associated hydraulic cylinders. Rear fenders 124 are provided to cover a portion of the rear wheels 114.

Within the cab 118, an operator station 126 is provided. The operator station 126 comprises a user interface device 128 which is used to display information relating to tractor operation, and to control different elements of the tractor 110. The operator station 126 is provided with a control lever 130, which can be used to operate different elements of the tractor 110, e.g. hydraulic circuits, lifting systems, and/or to control the acceleration and steering of the tractor 110.

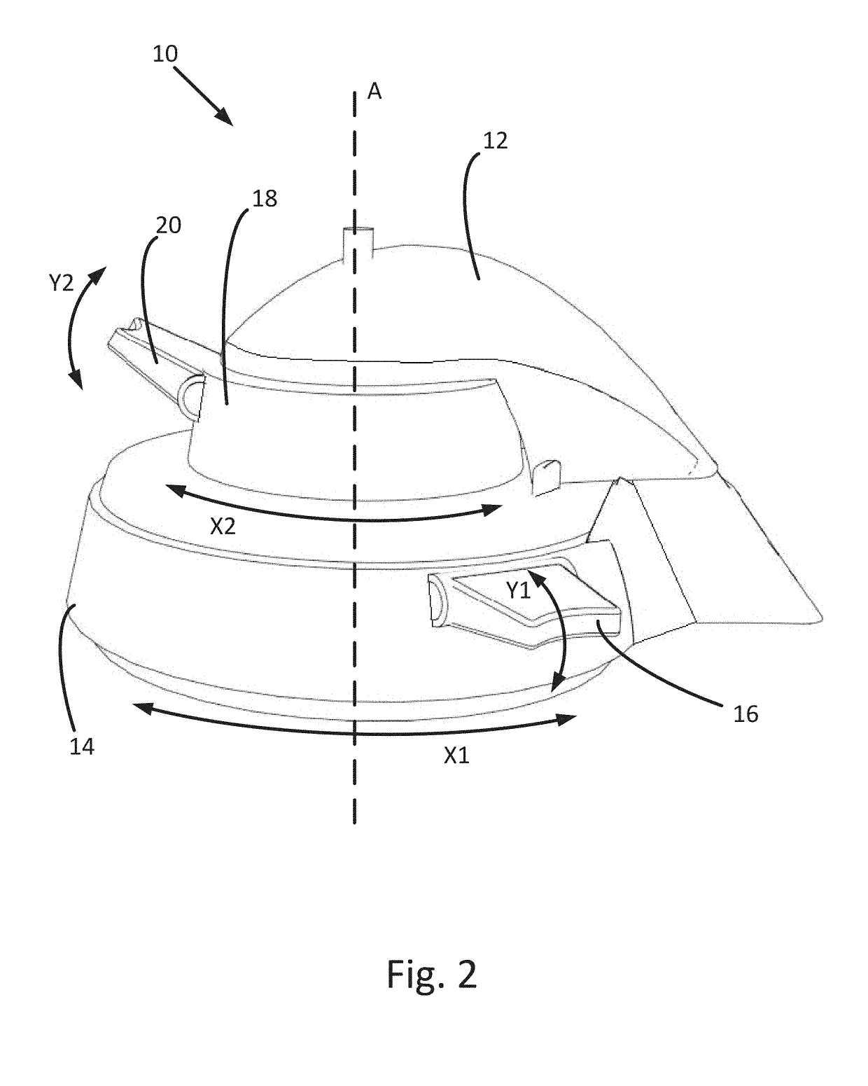

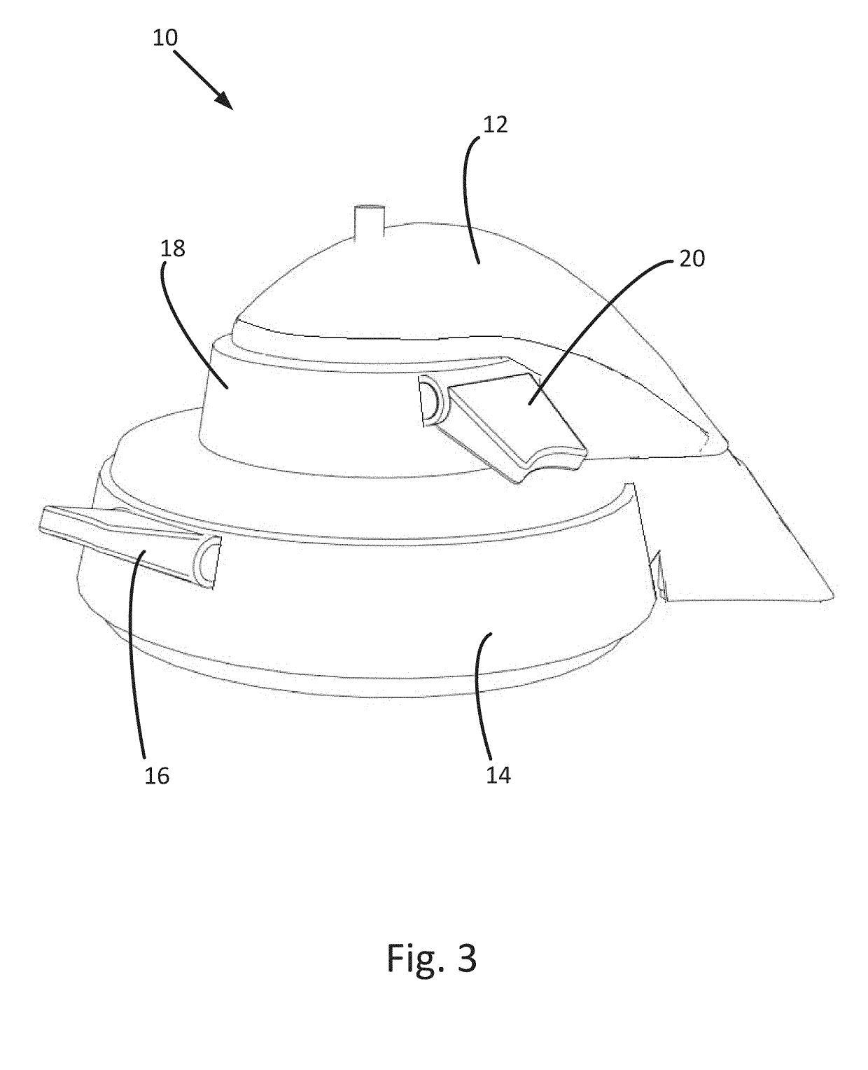

The operator station 126 is further provided with a switching device 10, which can be provided as part of an arm rest 132 for an operator. An enlarged view of a switching device 10 according to a first embodiment of the invention is provided in FIGS. 2 and 3.

The switching device 10 comprises a housing part 12 having a dome-like shape intended for the resting of an operator's hand. The switching device 10 comprises a first or primary switch in the form of a lower adjustment wheel 14 arranged towards the base of the switching device 10. The adjustment wheel 14 is provided in a substantially horizontal alignment, and is arranged to be rotated about a central axis A, which extends through the top of the housing part 12. The adjustment wheel 14 is arranged to lie beneath the fingers of an operator having a hand resting on the housing part 12, such that the wheel 14 can be easily and comfortably adjusted by the operator.

A second or secondary switch in the form of a rocker switch 16 is provided on the rim of the adjustment wheel 14, the rocker switch 16 carried by the adjustment wheel 14. Accordingly, as the adjustment wheel 14 is rotated about the central axis A, the rocker switch 16 is carried on the adjustment wheel 14. As a result, an operator can easily determine the position of the rocker switch 16 without looking at the switching device 10, by feeling for the switch 16 using their fingers.

In addition, the first and second switches 14, 16 can be configured to control related variables. For example, the adjustment wheel 14 may be used to set a desired height, extension, or depth of a vehicle component such as a front or rear hitch, a front loader, etc. The rocker switch 16 can then be used to control a second variable for the same vehicle component, e.g. a rapid raising or lowering of a hitch or implement, or any other positional variable which may include height, extension, or depth. Alternatively, the adjustment wheel 14 may be used to set a desired operational range for a component, e.g. an upper permissible height for a front loader, where the associated rocker switch 16 is used to adjust a variable of the component within the desired range, i.e. the height of the front loader up to the upper permissible height set by the wheel 14.

By configuring the first and second switches 14, 16 to adjust different variables which are related to the control of the same vehicle component, as a result an operator can easily determine the relationship between the first and second switches 14, 16 and actuate the switches 14, 16 without looking at the switching device 10 or repositioning their hand.

In one aspect of the invention, the rocker switch 16 can be positioned along the rim of the adjustment wheel 14 to act as an indicator or marker of the current variable value selected by rotation of the wheel 14.

The rocker switch 16 is arranged such that it is moveable or actuatable in a different direction to the direction of rotation of the adjustment wheel 14, the rocker switch 16 actuatable in a substantially vertical direction as indicated by arrow Y1, the adjustment wheel 14 rotatable along a path indicated by arrow X1 substantially parallel to the horizontal axis. Providing switches 14, 16 actuatable in different directions prevents inadvertent actuation of one switch while moving the other switch.

It will be understood that the configuration of a second switch carried on a first switch may be replicated to provide additional controls for components. In the illustrated embodiment, the switching device 10 further comprises an upper adjustment wheel 18 arranged above the lower adjustment wheel 14, the upper adjustment wheel 18 having a reduced diameter compared to the lower adjustment wheel 14, and arranged parallel to and concentric with the lower adjustment wheel 14. The upper adjustment wheel 18 is used to control a first variable of a further vehicle component. In addition, similar to the lower adjustment wheel 14, an upper rocker switch 20 is provided on the outer rim of the upper adjustment wheel 18, for control of a further vehicle component variable, preferably a second variable related to the first variable controlled by the upper adjustment wheel 18.

The switching device 10 may be configured to have any number of first and second switches, the second switches mounted or carried on the respective first switches.

As with the first and second switches of the lower adjustment wheel and rocker 14, 16, the upper rocker switch 20 is arranged such that it is moveable or actuatable in a different direction to the direction of rotation of the upper adjustment wheel 18, the rocker switch 20 actuatable in a substantially vertical direction as indicated by arrow Y2, the adjustment wheel 18 rotatable along a path indicated by arrow X2 substantially parallel to the horizontal axis. The relative movements of the different switching elements 14, 16, 18, 20 can be seen in FIG. 3, wherein the adjustment wheels 14, 18 have been moved to set different values for the respective first variables, and wherein the rocker switches 16, 20 can be controlled to adjust the values for the respective second variables.

The use of two adjustment wheels 14, 18 in the switching device 10 allows for a plurality of vehicle components to be easily and relatively comfortably controlled by an operator from the armrest 132. Further details on the internal construction of such a rotary switching device can be found in U.S. Pat. No. 7,654,359, the contents of which are incorporated by reference herein. While the second switches 16, 20 are provided as rocker switches in the above embodiment, it will be understood that any suitable switch device may be used, e.g. a pushbutton switch, a toggle switch, a scroll wheel, a rotary dial or disc.

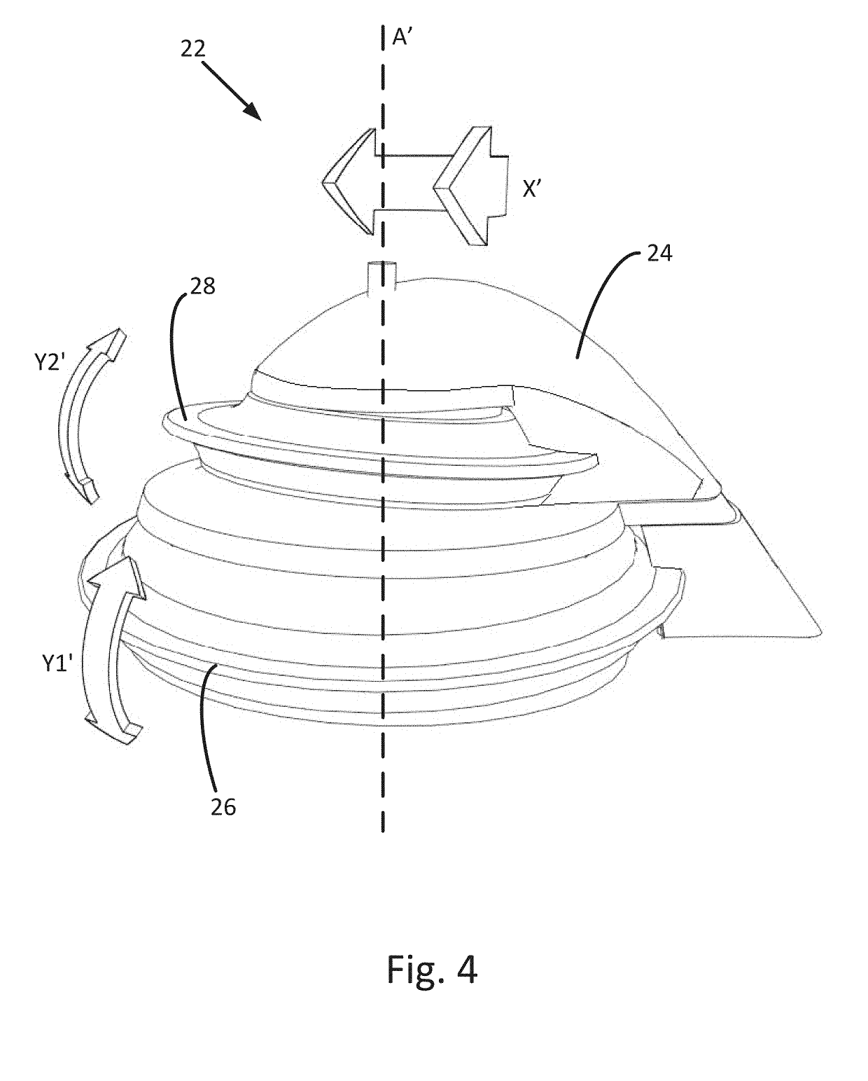

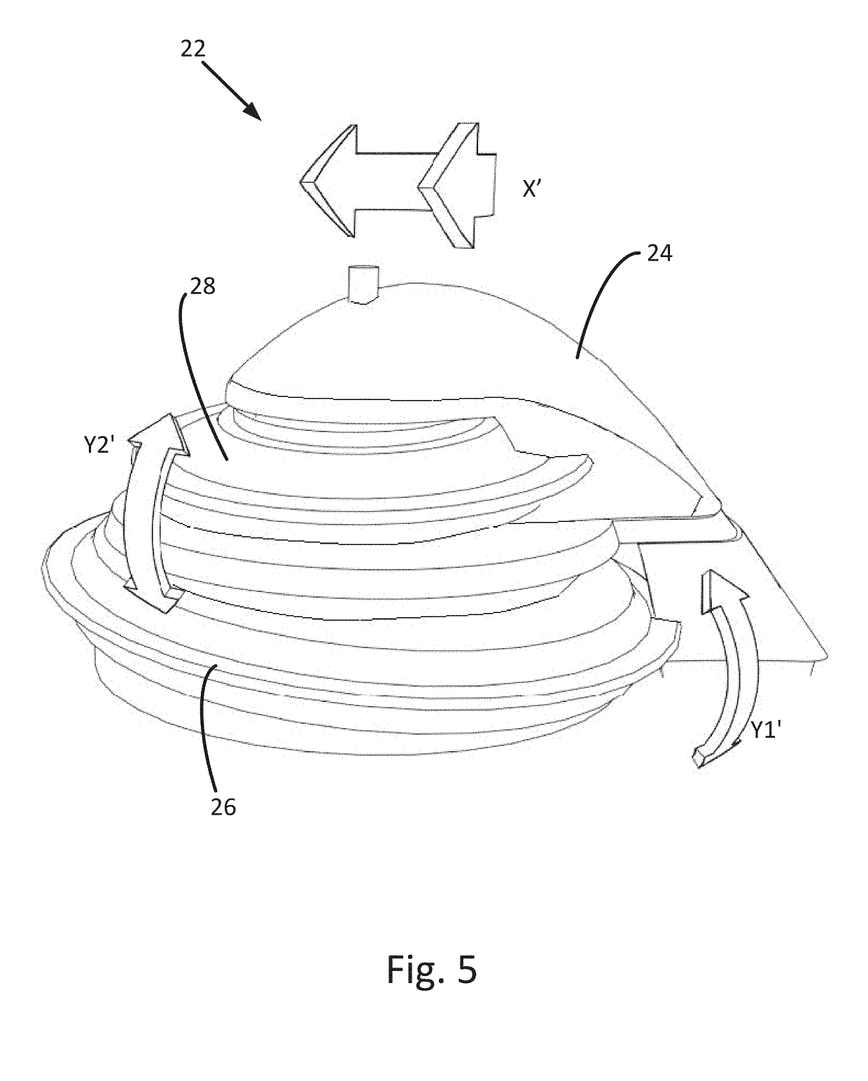

With reference to FIGS. 4 and 5, a second embodiment of switching device according to the invention is indicated at 22. The switching device 22 comprises a housing part 24 having a dome-like shape intended for the resting of an operator's hand. In this embodiment, the switching device 22 comprises a first switch in the form of a lower rotary disc 26 arranged towards the base of the switching device 22. The lower rotary disc 26 is arranged to be rotated about a central axis A′, which extends through the top of the housing part 24. The direction of rotation of the disc 26 is indicated by arrow X′, such that the rotary disc 26 can be used for control of a first variable of a vehicle.

The rotary disc 26 is arranged along a plane substantially parallel to the horizontal. The rotary disc 26 is pivotally mounted in the switching device 22 such that the planar angle of the disc 26 is adjustable along the direction of the arrow Y1′. In this case, a second switch of the rotary disc 26 is provided in the form of an angle detector (not shown) which is arranged to measure the planar angle of the disc 26 to the horizontal, for control of a second variable of the vehicle. Preferably, the second variable is a value for control of a vehicle component related to the component controlled by the rotation of the disc 26 along the path indicated by X′.

As with the first embodiment, the second embodiment of switching device 22 is provided with an upper rotary disc 28 arranged above and concentric with the lower rotary disc 26, and configured to be rotatable about the central axis A′ as indicated by arrow X′, for the control of a first variable of a further vehicle component. The upper rotary disc 28 is pivotally mounted in the switching device 22 such that the planar angle of the disc 28 is adjustable along the direction of the arrow Y2′. Adjustment of the planar angle is detected by a second switch in the form of an upper angle detector (not shown), for control of a second variable of the vehicle.

The relative movements of the different rotary discs 26, 28 and the associated angle detectors can be seen in FIG. 5, wherein the discs 26, 28 have been moved along the path indicated by arrow X′ to set different values for the respective first variables, and wherein the planar angles of the discs 26, 28 to the horizontal have been adjusted to control the values for the respective second variables.

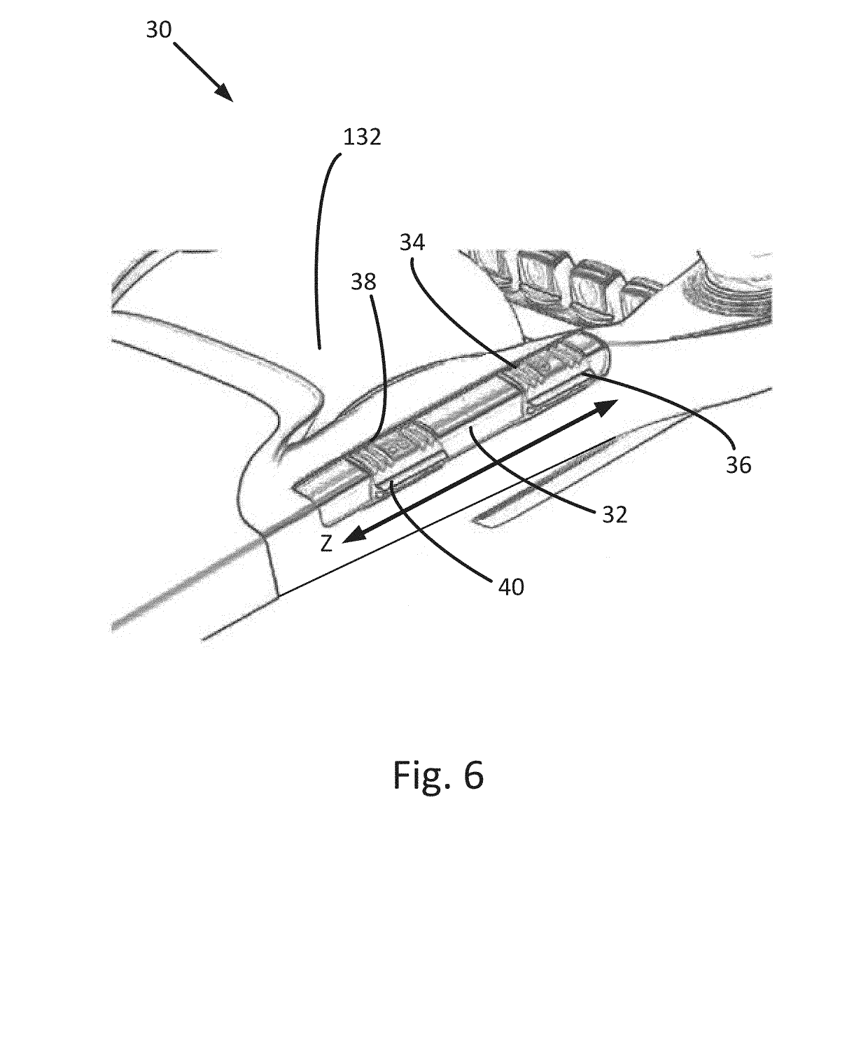

With reference to FIG. 6, a third embodiment of a switching device according to an aspect of the invention is indicated at 30. The switching device 30 is provided as part of an armrest 132 for a vehicle 110, a section of which is shown in FIG. 6. The switching device 30 comprises a longitudinal rail 32 provided on the armrest 132. A first switch 34 is provided in the form of a linear slide or linear shuttle switch, wherein the output of the switch 34 is based on the position of the shuttle body of the switch 34 along the length of the rail 32, as indicated by arrow Z. The output of the first switch 34 provides a first variable used to control the operation of a component of the vehicle 110.

A second switch 36 in the form of a rocker switch is provided on the side of the shuttle body of the switch 34, such that the second switch 36 is moved with the first switch 34 along the rail 32. The second switch 36 is used to output a second variable used to control the operation of a component of the vehicle 110. As with the embodiments described above, the switching device 30 is preferably configured such that the first and second switches 34, 36 are used for the control of related variables, preferably for the adjustment of different variables used to control a particular vehicle component.

The embodiment of FIG. 6 is further provided with an additional a linear slide or linear shuttle switch 38 moveable on the rail 32, the additional linear switch 38 having an additional rocker switch 40 provided on the side of the shuttle body of the switch 38, for the control of further first and second variables respectively. It will be understood that alternative configurations may comprise an array of linear slide or shuttle switches having secondary switched mounted thereon for control of a variety of vehicle variables, the array of switches provided on parallel rails arranged on an armrest 132 or as part of an operator station 126.

It will be understood that individual features of the different embodiments may be combined without departing from the scope of the invention. For example, different combinations of switch types may be used in the different switching devices. The use of a switching device wherein a secondary switch is provided carried on or mounted to a primary switch allows for an operator to easily move between actuation of the different switches without requiring the operator to look directly at the switching device. In addition, as the switches are commonly located, an operator can easily associate the variables controlled by the switches with each other.

The invention is not limited to the embodiments described herein, and may be modified or adapted without departing from the scope of the present invention.

1. A switching device for an agricultural vehicle, the switching device comprising:
a first switch moveable along a switch path in a first direction for control of a first variable of the vehicle, the first switch comprising a rotary switch; and
a second switch moveable in a second direction different to said first direction for control of a second variable of the vehicle,
wherein the second switch is carried on the first switch.

2. The switching device of claim 1, wherein the second switch comprises at least one of the following: a pushbutton switch, a rocker switch, a toggle switch, a scroll wheel.

3. The switching device of claim 1, wherein the first switch comprises an adjustment wheel, wherein the second switch is mounted on an outer rim of the adjustment wheel.

4. The switching device of claim 1, comprising an upper first switch and a lower first switch, the upper and lower first switches provided as concentric rotary switches, the upper and lower first switches having respective upper and lower second switches carried thereon.

5. A switching device for an agricultural vehicle, the switching device comprising:
a first switch moveable along a switch path in a first direction for control of a first variable of the vehicle, wherein the first switch comprises a rotatable disc, rotatable about a central axis for control of the first variable; and
a second switch moveable in a second direction different to said first direction for control of a second variable of the vehicle, wherein the second switch is carried on the first switch and controls the second variable by adjustment of the planar angle of the disc to the horizontal.

6. The switching device of claim 5, further comprising an angle detector to measure the planar angle of the disc to the horizontal, for control of the second variable.

7. The switching device of claim 5, configured such that when the disc is parallel to the horizontal, an angle detector outputs a zero value for control of the second variable.

8. The switching device of claim 1, wherein the first switch comprises a linear slide switch or linear shuttle switch and the first variable is controlled by movement of the slide switch or shuttle switch along a linear path, wherein the second switch is mounted on the slide switch or shuttle switch.

9. An agricultural vehicle, comprising:
at least one switching device comprising:
a first switch moveable along a switch path in a first direction for control of a first variable of the vehicle; and
a second switch moveable in a second direction different to said first direction for control of a second variable of the vehicle, wherein the second switch is carried on the first switch; and
at least one vehicle component controlled by said at least one switching device.

10. The agricultural vehicle of claim 9, wherein the at least one switching device is configured such that the first and second variables are related parameters for control of the at least one vehicle component.

11. The agricultural vehicle of claim 9, wherein the first variable controlled by the first switch, sets an operating range for the at least one vehicle component.

12. The agricultural vehicle of claim 9, wherein an operating range for the at least one vehicle component is set based on selection of at least one of the following variables: a component depth limit, a component height limit, and/or a component length limit.

13. The agricultural vehicle of claim 9, wherein the second variable controlled by the second switch limits operation of the at least one vehicle component to within an operating range set by the first variable.

14. The agricultural vehicle of claim 9, wherein the second switch controls a component depth, height and/or length variable, within the limits of the operating range set by the first variable.
